(19) United States
(12) Patent Application Publication
(10) Pub. No.: US 2026/0006529 A1
(43) Pub. Date: Jan. 1, 2026

(54) WIRELESS COMMUNICATION SYSTEM, CONTROL APPARATUS, RELAY STATION APPARATUS, AND DATA TRANSMISSION METHOD DETERMINATION METHOD

(71) Applicant: NIPPON TELEGRAPH AND TELEPHONE CORPORATION, Tokyo (JP)

(72) Inventors: Daisuke MURAYAMA, Tokyo (JP); Toshiro NAKAHIRA, Tokyo (JP); So TAKATANI, Tokyo (JP)

(73) Assignee: NIPPON TELEGRAPH AND TELEPHONE CORPORATION, Tokyo (JP)

(21) Appl. No.: 18/880,839

(22) PCT Filed: Jul. 7, 2022
(86) PCT No.: PCT/JP2022/027031

§ 371 Date: Jan. 2, 2025

(51) Int. Cl. H04W 40/12; H04W 72/56; H04W 88/06; H04W 88/10

(52) U.S. Cl. CPC H04W 40/12; H04W 72/56; H04W 88/06; H04W 88/10

(57) ABSTRACT

A wireless communication system including a relay station apparatus capable of relaying wireless communication between one or more base station apparatuses and a terminal apparatus using a plurality of systems, and a control apparatus, the relay station apparatus acquires the quality between the terminal apparatus and each base station apparatus for which the relay station apparatus performs relaying, and the relay station apparatus for each system, and notifies the control apparatus of the acquired quality, and the control apparatus determines a data transmission method for each of a communication path between each base station apparatus and the relay station apparatus and a communication path between the relay station apparatus and the terminal apparatus on the basis of the quality and the priority of the terminal apparatus, and notifies the relay station apparatus of the determined data transmission method.

### TECHNICAL FIELD

The present invention relates to a communication control technology in a network that accommodates a plurality of wireless systems.

### BACKGROUND ART

Wireless communication technologies such as 5G and wireless LAN are becoming widespread. In recent years, as disclosed in NPL 1, a technology for predicting the wireless quality of a terminal apparatus and selecting a wireless system (such as a base station apparatus) to which the terminal apparatus will be connected from among a plurality of wireless systems has been proposed.

The technology disclosed in NPL 1 makes it possible for the terminal apparatus to use the plurality of wireless systems in a crossing manner, maintain communication quality in the terminal apparatus, and improve user experience.

### CITATION LIST

### Non Patent Literature

[NPL 1] NTT Technology Journal (2020 April, P11-13)

### SUMMARY OF INVENTION

### Technical Problem

It is conceivable to perform detailed communication distribution control from the base station apparatus to the terminal apparatus in order to enable the terminal apparatus to use an appropriate wireless system on the basis of the technology disclosed in NPL 1. However, since there are terminal apparatuses that do not support such communication distribution control, it is difficult to cause the terminal apparatus to use an appropriate wireless system using the communication distribution control.

The present invention has been made in view of the above points, and an object of the present invention is to provide a technology for allowing a terminal apparatus to perform communication using an appropriate wireless system according to a capability thereof without performing distribution control on the terminal apparatus.

### Solution to Problem

According to the disclosed technology, a wireless communication system includes a relay station apparatus capable of relaying wireless communication between one or more base station apparatuses and a terminal apparatus using a plurality of systems, and a control apparatus, wherein the relay station apparatus acquires a quality between the terminal apparatus and each base station apparatus for which the relay station apparatus performs relaying, and the relay station apparatus for each system, and notifies the control apparatus of the acquired quality, and

the control apparatus determines a data transmission method for each of a communication path between each base station apparatus and the relay station apparatus and a communication path between the relay station apparatus and the terminal apparatus on the basis of the quality and the priority of the terminal apparatus, and notifies the relay station apparatus of the determined data transmission method.

### Advantageous Effects of Invention

According to the disclosed technology, it is possible for a terminal apparatus to perform communication using an appropriate wireless system according to capability without performing distribution control on the terminal apparatus.

### BRIEF DESCRIPTION OF DRAWINGS

FIG. 1 is diagram illustrating an example of an overall configuration of a wireless communication system.

FIG. 2 is a diagram illustrating Example 1 of a configuration of the apparatus.

FIG. 3 is a diagram illustrating Example 1 of a configuration of the apparatus.

FIG. 4 is a diagram illustrating Example 2 of the configuration of the apparatus.

FIG. 5 is a diagram illustrating Example 2 of the configuration of the apparatus.

FIG. 6 is a diagram illustrating an image of an operation.

FIG. 7 is a flowchart of the operation.

FIG. 8 is a diagram illustrating an example of a table.

FIG. 9 is a diagram illustrating an example of a hardware configuration of the device.

### DESCRIPTION OF EMBODIMENTS

Hereinafter, embodiments of the present invention (the present embodiment) will be described with reference to the drawings. The embodiments described below are merely examples, and embodiments to which the present invention is applied are not limited to the following embodiments. The “base station apparatus” described below may be replaced with “access point (AP).” Further, a meaning of “base station apparatus” may include an AP.

### EXAMPLE OF OVERALL SYSTEM CONFIGURATION

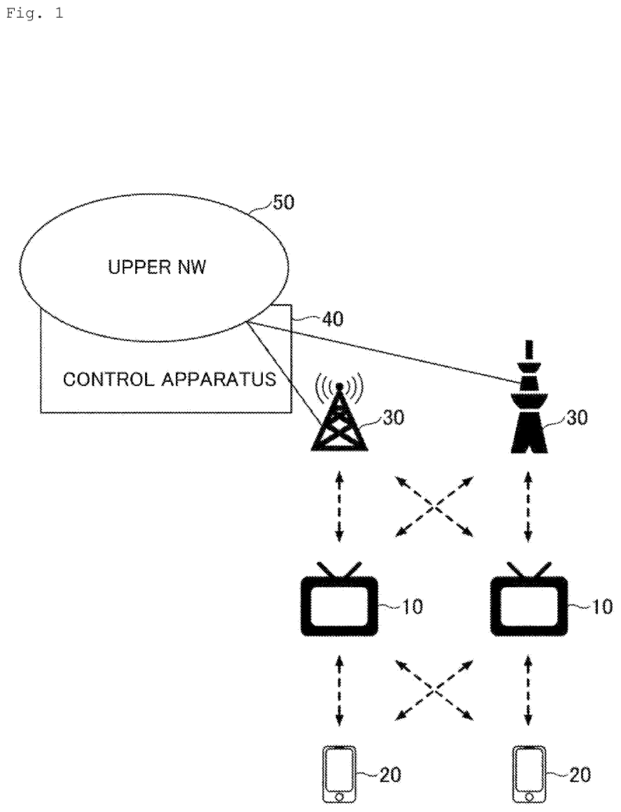

FIG. 1 illustrates an example of an overall configuration of a wireless communication system in the present embodiment. As illustrated in FIG. 1, the present wireless communication system includes one or more terminal apparatuses 20, one or more relay station apparatuses 10, one or more base station apparatuses 30, and a control apparatus 40.

In the example illustrated in FIG. 1, the control apparatus 40 is provided on the upper network (NW) 50. However, the control apparatus 40 may be provided anywhere. For example, a function of the control apparatus 40 may be provided in any one of the terminal apparatus 20, the relay station apparatus 10, and the base station apparatus 30. Further, any apparatus having the function of the control apparatus 40 may be referred to as a “control apparatus.”

The terminal apparatus 20 is an apparatus that can wirelessly communicate with the relay station apparatus 10 or the base station apparatus 30, and includes an interface of a single wireless system or an interface of a plurality of different wireless system. Among a plurality of terminal apparatuses 20, a terminal apparatus that connects to the base station apparatus 30 via the relay station apparatus 10 and the terminal apparatus 20 that connects to the base station apparatus 30 directly may coexist.

The relay station apparatus 10 relays communication between the terminal apparatus 20 and the base station apparatus 30. The relay station apparatus 10 includes an interface for a plurality of different wireless systems. The relay station apparatus 10 may also be called an accommodation distribution relay station apparatus.

The base station apparatus 30 transmits a signal received wirelessly from the terminal apparatus 20 to the upper NW 50, and wirelessly transmits a signal received from the upper NW 50 to the terminal apparatus 20. It is assumed that a plurality of different wireless systems coexist in the plurality of base station apparatuses 10. However, the plurality of base station apparatuses 10 may be only a single wireless system.

“Wireless system” may also be referred to as system, wireless communication scheme, wireless method, communication scheme, radio access technology (RAT), or the like. Examples of “wireless systems” include 3G, 4G, 5G, 6G, wireless LAN, WiMAX, and the like. In the following description, a “wireless system” may be referred to as a “system.”

The upper NW 50 may be a core network of a mobile network (for example, 5G), the Internet, or a network other than these.

The control apparatus 40 performs distribution control (determination of transmission method), which will be described below. The control apparatus 40 notifies the relay station apparatus 10 of the determined transmission method. Further, instead of the control apparatus 40 determining the transmission method, the relay station apparatus 10 may determine the transmission method. Further, communication of a terminal apparatus whose transmission method is determined by the control apparatus 40 and communication of a terminal apparatus whose transmission method is determined by the relay station apparatus 10 may coexist.

The base station apparatus 30 and the control apparatus 40 are connected by wire. However, the base station apparatus 30 and the control apparatus 40 may be connected wirelessly. When wireless connection is used, Integrated Access Backhaul (IAB), WiGig, or the like may be used.

### Example 1 of Apparatus Configuration

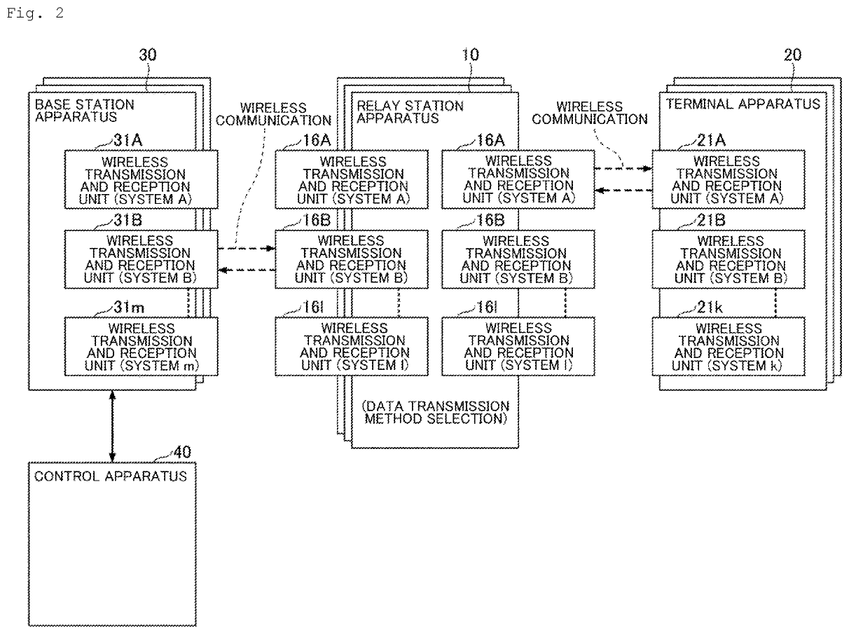

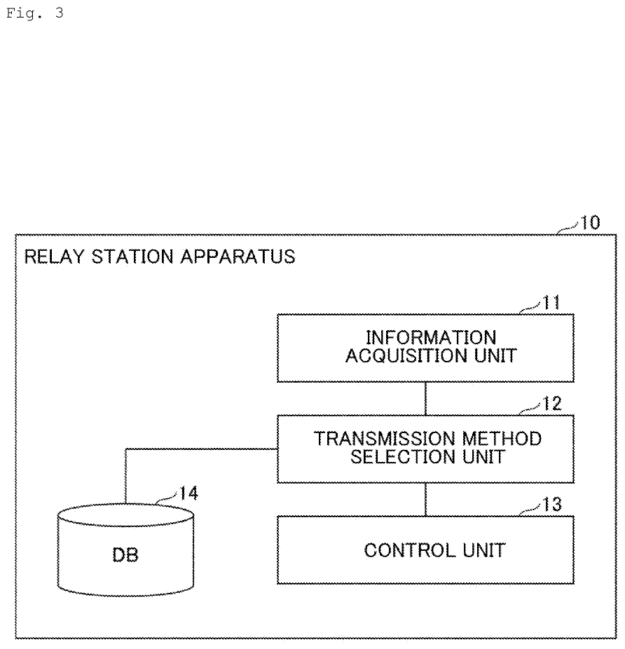

FIG. 2 illustrates a configuration of each apparatus in the wireless communication system described above. FIG. 2 illustrates Example 1 in which the relay station apparatus 10 determines the transmission method. Further, FIG. 3 illustrates a functional configuration of the relay station apparatus 10 of Example 1 other than the wireless transmission and reception unit.

As illustrated in FIG. 2, the relay station apparatus 10 includes a wireless transmission and reception unit 16 for each system. Further, as illustrated in FIG. 3, the relay station apparatus 10 includes an information acquisition unit 11, a transmission method selection unit 12, a control unit 13, and a database (DB) 14. The “wireless transmission and reception unit” may also be referred to as an “interface.”

As illustrated in FIG. 2, the terminal apparatus 20 includes a wireless transmission and reception unit 21 for each system. The base station apparatus 30 includes a wireless transmission and reception unit 31 for each system.

In Example 1, the information acquisition unit 11 of the relay station apparatus 10 acquires the quality, the capability information (Capability) of the terminal apparatus 20, the priority of the terminal apparatus 20 (or APP), or the like, and the transmission method selection unit 12 uses these pieces of information to determine the transmission method. The control unit 13 executes, for example, establishment of a communication path using the determined transmission method.

FIG. 2 illustrates an example of a case in which system A is selected as a communication scheme between the terminal apparatus 20 and the relay station apparatus 10, and system B is selected as a communication scheme between the relay station apparatus 10 and the base station apparatus 30.

### Example 2 of Apparatus Configuration

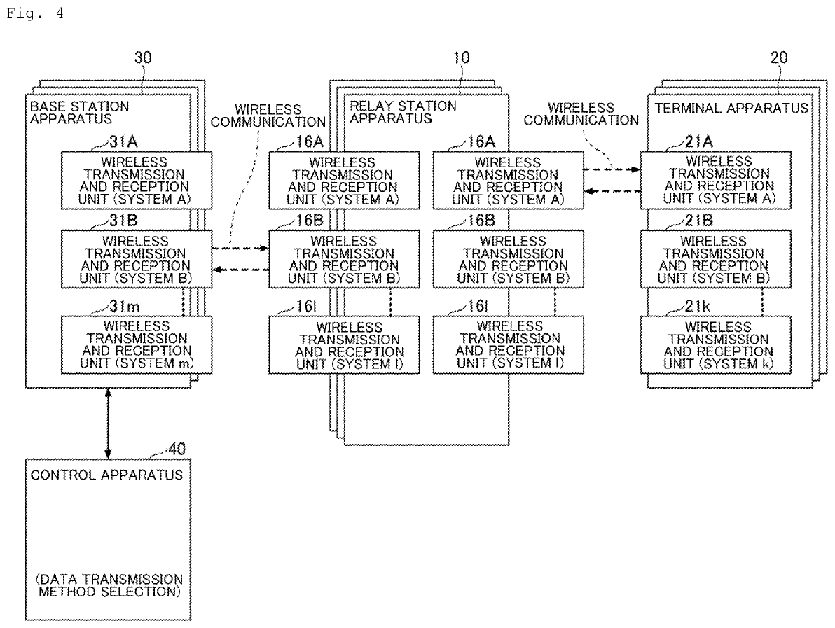

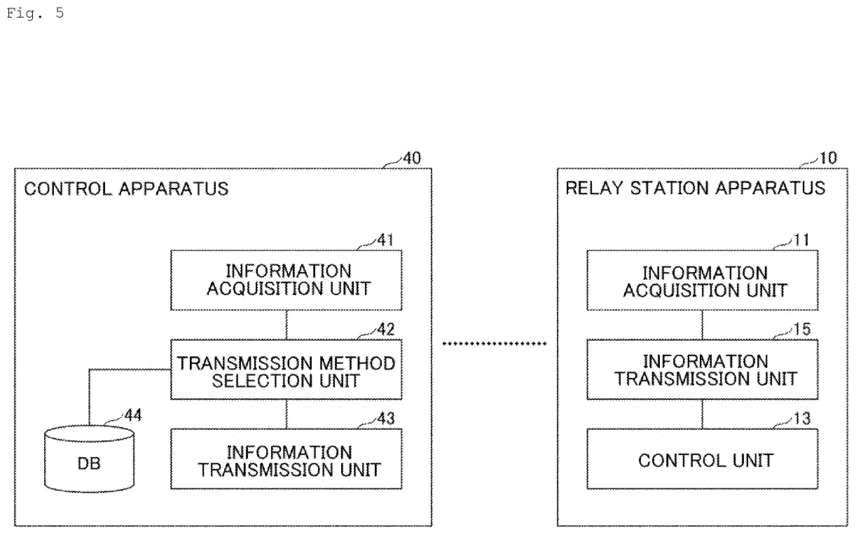

FIG. 4 illustrates Example 2 in which the control apparatus 40 determines the transmission method. Further, FIG. 5 illustrates a functional configuration other than the wireless transmission and reception unit and a functional configuration of the control apparatus 40 in the relay station apparatus 10 of Example 2.

As illustrated in FIG. 4, the relay station apparatus 10 includes a wireless transmission and reception unit 16 for each system. As illustrated in FIG. 5, the relay station apparatus 10 includes an information acquisition unit 11, an information transmission unit 15, and a control unit 13. The control apparatus 40 includes an information acquisition unit 41, a transmission method selection unit 42, an information transmission unit 43, and a database (DB) 44.

As illustrated in FIG. 4, the terminal apparatus 20 includes a wireless transmission and reception unit 21 for each system. The base station apparatus 30 includes a wireless transmission and reception unit 31 for each system.

In Example 2, the information acquisition unit 11 of the relay station apparatus 10 acquires the same information as in Example 1, and the information transmission unit 15 transmits the information to the control apparatus 40. The transmission method selection unit 42 of the control apparatus 40 uses the information to determine the transmission method, and the information transmission unit 43 transmits the determination result to the relay station apparatus 10. The control unit 13 of the relay station apparatus 10 establishes a communication path using the determined transmission method.

### OPERATION EXAMPLE

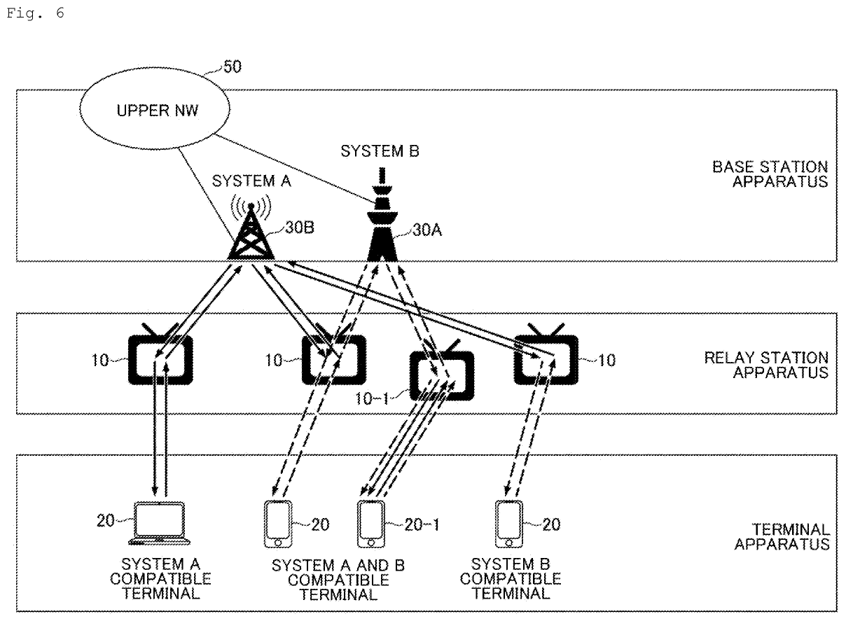

Hereinafter, an example of the operation of a wireless communication system having the above configuration will be described. FIG. 6 is a diagram illustrating an image of the operation. For example, when a terminal apparatus 20-1 that supports both systems A and B issues a communication request, the relay station apparatus 10-1 which can establish communication with the terminal apparatus 20-1 determines (selects) a transmission method (also referred to as a data transmission method) for the terminal apparatus 20-1.

The transmission method here is a method (information) indicating whether the transmission is to be performed by using a certain system and a certain method for communication path 1 between “relay station apparatus-base station apparatus” and communication path 2 between “terminal apparatus-relay station apparatus”. Further, in the present embodiment, the transmission method determined for each of communication path 1 and communication path 2 may be applied to bidirectional communication or may be applied to only unidirectional communication. When the transmission method is applied to only one-way communication, another transmission method may be applied to communication in another direction.

Hereinafter, an operation example of the configuration of Example 1 (FIGS. 2 and 3) will be described as Operation Example 1, and an operation example of the configuration of Example 2 (FIGS. 4 and 5) will be described as Operation Example 2.

When the relay station apparatus 10 relays a system that requires synchronization, such as 5G cellular, the relay station apparatus 10 needs to be synchronized with the base station apparatus 30 and the terminal apparatus 20 in advance. Therefore, when a system based on synchronization is assumed, the relay station apparatus 10 is synchronized with the base station apparatus 30 and the terminal apparatus 20 in advance as a premise of the following operation example.

As a specific synchronization method, for synchronization between the relay station apparatus 10 and the base station apparatus 30, for example, a synchronization signal Primary Synchronization Signal (PSS)/Secondary Synchronization Signal (SSS) from the base station apparatus 30 may be used, similar to an initial access procedure of 5G New Radio. The synchronization signal may be periodically transmitted from the base station apparatus 30, and the clock of the relay station apparatus 10 may be updated each time the synchronization signal is received. Further, the synchronization between the relay station apparatus 10 and the terminal apparatus 20 may be realized, by each being synchronized with a synchronization signal of the base station apparatus 30, or the relay station apparatus 10 periodically transmitting a synchronization signal and the terminal apparatus 20 updating a clock according to the synchronization signal.

### Operation Example 1

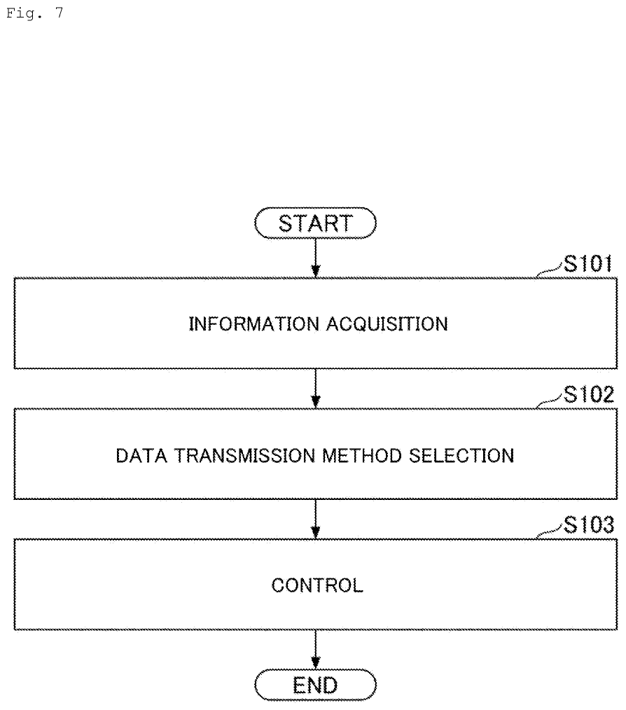

Operation Example 1 will be described according to a procedure of the flowchart in FIG. 7. Hereinafter, an operation for establishing communication with respect to a certain terminal apparatus 20 (target terminal apparatus 20) will be described.

### S101

In S101, the information acquisition unit 11 of the relay station apparatus 10 acquires the connection quality (also referred to as wireless quality, reception quality, or the like) between the target terminal apparatus 20 and the relay station apparatus 10, and the connection quality between the base station apparatus 30 and the relay station apparatus 10 with which communication with the relay station apparatus 10 can be established. The connection quality may be reception quality/reception power on the relay station apparatus 10 side, or may be reception quality/reception power on the terminal apparatus 20 side/base station apparatus 30 side. When one apparatus supports a plurality of systems, the connection quality for each system is acquired.

As connection quality, in 5G or the like, for example, Synchronization Signal reference signal received power (SS-RSRP) or Signal-to-interference-plus-noise ratio (SINR) is acquired. In the wireless LAN, for example, Received Signal Strength Indicator (RSSI) is acquired. SS-RSRP is a linear average power value of a resource element that carries a secondary synchronization signal.

The information acquisition unit 11 may also obtain a maximum throughput from a correspondence table (reception power-maximum throughput correspondence table) acquired in advance for each wireless system and communication path (relay station apparatus-terminal apparatus, relay station-base station, or the like), and calculate a value obtained by dividing this maximum throughput proportionally by the number of connected apparatuses, as the predicted communication quality (throughput).

For example, it is assumed that 300 Mbps is obtained from the correspondence table as the maximum throughput from the reception power in the terminal apparatus 20A, in the path between the relay station apparatus 10A and the terminal apparatus 20A that performs communication in system A. Further, when it is assumed that the plurality of terminal apparatuses 20 that perform communication in the system A are connected to the relay station apparatus 10A at the same time, for example, the information acquisition unit 11 sets 150 Mbps as predicted communication quality (throughput) in the “relay station apparatus 10A-terminal apparatus 20A”. This predicted throughput may be the throughput from the relay station apparatus 10A to the terminal apparatus 20A, the throughput from the terminal apparatus 20 to the relay station apparatus 10A, or the throughput of both.

Further, the information acquisition unit 11 may use a machine learning model to learn the output throughput in advance using received power, the number of connected apparatuses, or the like as input, and predict the throughput using the learned model. Connection quality, reception quality, reception power, communication quality, or the like may be collectively referred to as “quality.”

For example, regarding the connection quality with the base station apparatus 30, when there is “base station apparatus 30-1 and base station apparatus 30-2” for each of system A and system B as apparatuses that can establish communication with the relay station apparatus 10, the information acquisition unit 11 acquires the connection quality (or communication quality) for (“between the relay station apparatus 10 and the base station apparatus 30-1” and “between the relay station apparatus 10 and the base station apparatus 30-2”) for system A and acquires the connection quality (or communication quality) for (“between the relay station apparatus 10 and the base station apparatus 30-1” and “between the relay station apparatus 10 and the base station apparatus 30-2”) for system B.

Further, in S101, the information acquisition unit 11 attempts to connect to the terminal apparatus 20 using a wireless system compatible with the relay station apparatus 10, thereby ascertaining the terminal capability (systems supported by the terminal apparatus 20, or the like). Terminal Capability may include priority.

It is assumed that in S101, all pieces of information necessary for selecting the transmission method in S102 is acquired.

### S102

In S102, the transmission method selection unit 12 of the relay station apparatus 10 selects (determines) a data transmission method between the relay station apparatus 10 and the terminal apparatus 20 and the data transmission method between relay station apparatus 10 and base station apparatus 30, on the basis of the connection quality (or calculated communication quality) acquired in S101. Details of the selection method will be described below.

### S103

In S103, the control unit 13 of the relay station apparatus 10 establishes a communication path between the relay station apparatus 10 and the terminal apparatus 20 according to the selection result in S102, establishes a communication path between the relay station apparatus 10 and the base station apparatus 30, and starts communication using these communication paths.

### Selection Method for Data Transmission Method

The data transmission method selection processing executed by the transmission method selection unit 12 will be described. The transmission method selection unit 12 selects any one of redundant transmission, division transmission, and selective transmission as the data transmission method on the basis of the quality of the communication path, the terminal priority, the priority of the application (APP) being used by the terminal apparatus 20, the request delay time, or the like. However, using the redundant transmission, division transmission, and selective transmission are examples, and transmission methods other than these may also be used.

Redundant transmission is a transmission method that transmits redundant signals over a plurality of communication paths. Although this transmission method uses a large amount of radio resources, it is possible to increase a possibility that the connection can be maintained for sudden shielding, and to expect improved reliability.

Division transmission is a transmission method in which a signal is divided and transmitted over a plurality of communication paths. With this transmission method, it is possible to avoid a loss of all pieces of data due to sudden shielding, or the like, and to expect transmission similar to redundant transmission.

Selective transmission is a transmission method of selecting a single communication path and transmitting a signal. With this transmission method, communication quality can be selected to some extent depending on the selected communication path. The specific selection procedure is as follows.

### S1

First, the transmission method selection unit 12 selects a communication path satisfying predetermined quality among the communication paths for each system as a communication path selection candidate on the basis of the quality acquired by the information acquisition unit 11. The communication path satisfying predetermined quality (quality reference) is, for example, a communication path in which SS-RSRP of the communication path as a determination target is equal to or higher than Q when the quality is SS-RSRP and the predetermined quality value is Q.

As an example, it is assumed that the terminal apparatus 20, the relay station apparatus 10, and the base station apparatus 30 can each use systems A, B, and C, and that the following quality of each communication path is obtained. In this example, one base station apparatus 30 may be able to use systems A, B, and C, or a plurality of base station apparatuses 30 may be able to use systems A, B, and C (for example, when base station apparatuses 30A, 30B, and 30C are present).
Communication path 1A: “Relay station apparatus 10-base station apparatus 30” of system A
Communication path 1B: “Relay station apparatus 10-base station apparatus 30” of system B
Communication path 1C: “Relay station apparatus 10-base station apparatus 30” of system C
Communication path 2A: “Relay station apparatus 10-terminal apparatus 20” of system A
Communication path 2B: “Relay station apparatus 10-terminal apparatus 20” of system B
Communication path 2C: “Relay station apparatus 10-terminal apparatus 20” of system C

Among the above, when each of the communication path 1A, communication path 1B, communication path 2A, and communication path 2C satisfies the quality reference (the other paths do not satisfy the quality reference), the transmission method selection unit 12 selects the communication path 1A, Communication path 1B, communication path 2A, and communication path 2C as communication path candidates.

When one system has a plurality of communication paths, the communication path with the highest quality may be selected, or a plurality of communication paths may be selected as candidates in one system. When a plurality of communication paths are selected as candidates in one system, a redundant configuration using a plurality of communication paths in one system may be included in transmission method options to be described below.

### S2

Next, the transmission method selection unit 12 selects (determines) the data transmission method for the terminal apparatus 20 according to the priority of the terminal apparatus 20 or the priority of the application used by the terminal apparatus 20, on the basis of the communication path candidate selected in S1. The specific processing is as follows. “The priority of the terminal apparatus 20 or the priority of the application used by the terminal apparatus 20” is described as “terminal (APP) priority.” “Terminal priority” may also include the meaning of the priority of the application used by the terminal apparatus 20.

Here, the data transmission method to be used preferentially is prepared as a table (a table in which the priority is associated with the data transmission method) for each terminal (application) priority, and the table is stored in the DB 14. The transmission method selection unit 12 refers to this table to determine the data transmission method.

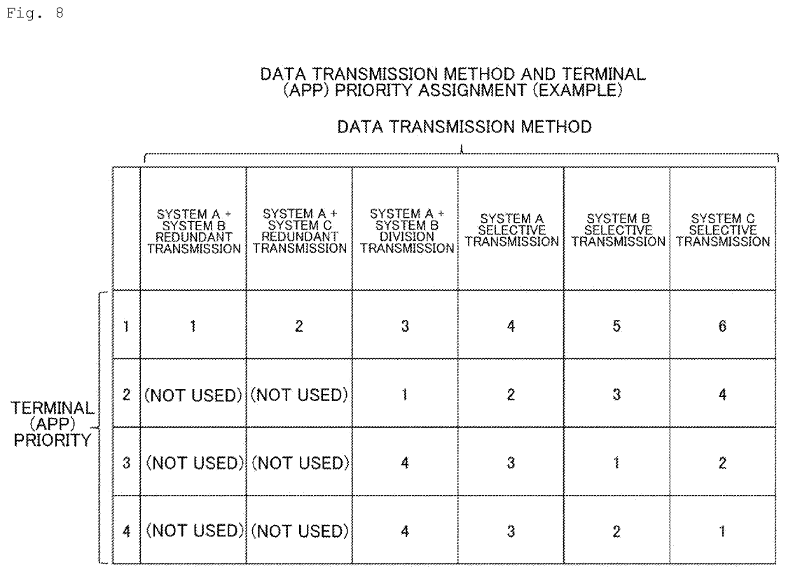

FIG. 8 illustrates an example of the table. As illustrated in FIG. 8, the “data transmission method” here refers to which system is used and which transmission method is used. The numbers in the table indicate usage priority. For example, when the terminal (APP) priority is 1, “system A+system B redundant transmission” whose priority is 1 is used with the highest priority. When “system A+system B redundant transmission” cannot be used, but “system A+system C redundant transmission” whose priority is 2 can be used, “system A+system C redundant transmission” is used.

The transmission method selection unit 12 selects the data transmission method for the target terminal apparatus 20 by referring to the table of FIG. 8 on the basis of the terminal (APP) priority of the target terminal apparatus 20 and the communication path selection candidates selected in S1.

As mentioned above, it is assumed that the following communication path is selected as a communication path selection candidate.
Communication path 1A: “Relay station apparatus 10-base station apparatus 30” of system A
Communication path 1B: “Relay station apparatus 10-base station apparatus 30” of system B
Communication path 2A: “Relay station apparatus 10-terminal apparatus 20” of system A
Communication path 2C: “Relay station apparatus 10-terminal apparatus 20” of system C

The data transmission method selected for each of the terminal (APP) priorities 1 to 4 of the target terminal apparatus 20 will be described hereinafter. The transmission method selection unit 12 may ascertain the usage status of each transmission method, and select a transmission method with one lower priority from among the available transmission methods for transmission methods that exceed the capacity upper limit value when selected.

### Terminal (APP) Priority 1

The transmission method selection unit 12 selects “system A+system B redundant transmission” for the communication path 1 of “relay station apparatus 10-base station apparatus 30”, and selects “system A+system C redundant transmission” for the communication path 2 of “relay station apparatus 10-terminal apparatus 20”.

### Terminal Priority 2

The transmission method selection unit 12 selects “system A+system B division transmission” for the communication path 1 of “relay station apparatus 10-base station apparatus 30”, and selects “system A selective transmission” for the communication path 2 of “relay station apparatus 10-terminal apparatus 20”.

### Terminal Priority 3

The transmission method selection unit 12 selects “system B selection transmission” for communication path 1 of “relay station apparatus 10-base station apparatus 30”, and selects “system C selection transmission” for communication path 2 of “relay station apparatus 10-terminal apparatus 20”.

### Terminal Priority 4

The transmission method selection unit 12 selects “system B selection transmission” for communication path 1 of “relay station apparatus 10-base station apparatus 30”, and selects “system C selection transmission” for communication path 2 of “relay station apparatus 10-terminal apparatus 20”.

### Operation Example 2

Next, Operation Example 2, which is an operation example in the configuration of Example 2 (FIGS. 4 and 5), will be described. Since a basic processing flow is the same as that of Operation Example 1, Operation Example 2 will also be described with reference to the flowchart of FIG. 7 in the same way as Operation Example 1. The same processing as in Operation Example 1 will be omitted or only a simple description will be given.

### S101

In S101, the information acquisition unit 11 of the relay station apparatus 10 acquires the connection quality (or communication quality), terminal capability, or the like of each communication path, as in the processing in Operation Example 1. The information transmission unit 15 of the relay station apparatus 10 transmits the information acquired by the information acquisition unit 11 to the control apparatus 40. The information acquisition unit 41 of the control apparatus 40 acquires the information.

### S102

In S102, the transmission method selection unit 42 of the control apparatus 40 selects a data transmission method between the relay station apparatus 10 and the terminal apparatus 20, and a data transmission method between the relay station apparatus 10 and the base station apparatus 30 on the basis of the connection quality (or the calculated communication quality) obtained in S101. The control apparatus 40 includes a DB 44 that stores the table illustrated in FIG. 8, and the transmission method selection unit 42 of the control apparatus 40 refers to the DB 44 to select a data transmission method. The processing for selecting the data transmission method is the same as in Operation Example 1.

The information transmission unit 43 of the control apparatus 40 transmits the data transmission method selection result of the transmission method selection unit 42 to the relay station apparatus 10 that is an information transmission source. The information acquisition unit 11 of the relay station apparatus 10 acquires the data transmission method selection result.

### S103

As in Operation Example 1, in S103, the control unit 13 of the relay station apparatus 10 establishes a communication path between the relay station apparatus 10 and the terminal apparatus 20 and establishes a communication path between the relay station apparatus 10 and the base station apparatus 30 according to the selection result in S102, and starts communication using these communication paths.

### Hardware Configuration Example

The terminal apparatus 20, relay station apparatus 10, base station apparatus 30, and control apparatus 40 can all be realized, for example, by causing a computer to execute a program. This computer may be a physical computer or a virtual machine on a cloud. Hereinafter, “terminal apparatus 20, relay station apparatus 10, base station apparatus 30, and control apparatus 40” will be collectively referred to as “apparatus.”

That is, the apparatus can be realized by executing a program corresponding to the processing performed by the apparatus using hardware resources such as a CPU and memory built into the computer. The program can be recorded on a computer-readable recording medium (a portable memory or the like), stored, and distributed. It is also possible to provide the program through a network such as the Internet or e-mail.

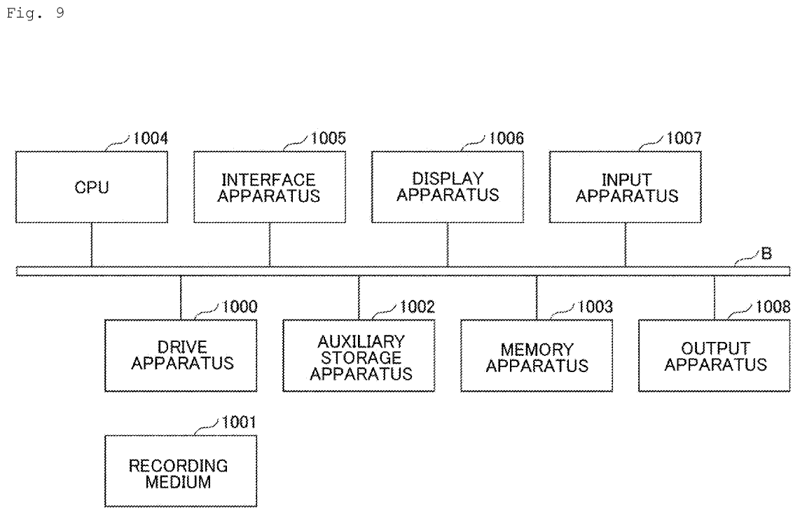

FIG. 9 is a diagram illustrating an example of a hardware configuration of the computer. The computer of FIG. 9 includes a drive apparatus 1000, an auxiliary storage apparatus 1002, a memory apparatus 1003, a CPU 1004, an interface apparatus 1005, a display apparatus 1006, an input apparatus 1007, an output apparatus 1008, and the like which are connected to each other via a bus BS.

A program for realizing processing in the computer is provided by, for example, a recording medium 1001 such as a CD-ROM or a memory card. When the recording medium 1001 having the program stored therein is set in the drive apparatus 1000, the program is installed in the auxiliary storage apparatus 1002 from the recording medium 1001 via the drive apparatus 1000. However, the program does not necessarily have to be installed from the recording medium 1001, and may be downloaded from another computer via a network. The auxiliary storage apparatus 1002 stores the installed program and also stores necessary files, data, and the like.

The memory apparatus 1003 reads and stores the program from the auxiliary storage apparatus 1002 when there is an instruction to start the program. The CPU 1004 realizes functions related to the apparatus according to the program stored in the memory apparatus 1003.

The interface apparatus 1005 is used as an interface for connection to a network. The display apparatus 1006 displays a graphical user interface (GUI) or the like according to a program. The input apparatus 1007 is configured of a keyboard, a mouse, buttons, a touch panel, or the like, and is used to input various operation instructions. The output apparatus 1008 outputs a calculation result. Any or all of the display apparatus 1006, the input apparatus 1007, and the output apparatus 1008 may not be included.

### Effects of Embodiment

As described above, with the technology according to the embodiment, it is possible for a terminal apparatus to perform communication using an appropriate wireless system according to capability without performing distribution control on the terminal apparatus. That is, it is possible to perform system-crossing radio resource control according to the functions of the terminal apparatus without directly controlling the terminal apparatus. This makes it possible to achieve an efficient and economical operation of a high-quality network that utilize a plurality of wireless systems.

Further, in the table of FIG. 8, the order of priority transmission methods used is switched or reversed between high priority terminals (APP) and low priority terminals (APP). In other words, when the priority of the terminal is low, resources of a quality assurance system are not consumed. In other words, the data transmission method is selected so that less resources are used when the priority is low than when the priority is high.

Thus, the resources of the quality assurance system that can accommodate high priority terminals (APP) are left without being consumed as much as possible, making it possible to avoid quality deterioration of the high priority terminals (APP) due to bandwidth tightness.

### APPENDIX

The present specification discloses at least the wireless communication system, the control apparatus, the relay station apparatus, and the data transmission method determination method in the following respective items.

### Appendix 1

A wireless communication system including a relay station apparatus capable of relaying wireless communication between one or more base station apparatuses and a terminal apparatus using a plurality of systems, and a control apparatus, wherein the relay station apparatus acquires the quality between the terminal apparatus and each base station apparatus for which the relay station apparatus performs relaying, and the relay station apparatus for each system, and notifies the control apparatus of the acquired quality, and
the control apparatus determines a data transmission method for each of a communication path between each base station apparatus and the relay station apparatus and a communication path between the relay station apparatus and the terminal apparatus on the basis of the quality and the priority of the terminal apparatus, and notifies the relay station apparatus of the determined data transmission method.

### Appendix 2

The wireless communication system according to appendix 1, wherein the data transmission method is redundant transmission, division transmission, or selective transmission.

### Appendix 3

The wireless communication system according to appendix 1 or 2, wherein the control apparatus determines the data transmission method for each communication path by referring to a table describing a relationship between priority and the data transmission method.

### Appendix 4

The wireless communication system according to any one of appendices 1 to 3, wherein
when the priority of the terminal apparatus is a first priority, the control apparatus determines a data transmission method using less resources than an amount of resources used in a data transmission method determined for a second priority higher than the first priority.

### Appendix 5

A control apparatus in a wireless communication system including a relay station apparatus capable of relaying wireless communication between one or more base station apparatuses and a terminal apparatus using a plurality of systems, and the control apparatus, the control apparatus including:
a memory; and
at least one processor connected to the memory, wherein the processor acquires, from the relay station apparatus, the quality of each system between the terminal apparatus and each base station apparatus for which the relay station apparatus performs relaying, and the relay station apparatus,
determines a data transmission method for each of a communication path between each base station apparatus and the relay station apparatus and a communication path between the relay station apparatus and the terminal apparatus on the basis of the quality and the priority of the terminal apparatus; and
notifies the relay station apparatus of the determined data transmission method.

### Appendix 6

A relay station apparatus capable of relaying wireless communication between one or more base station apparatuses and a terminal apparatus using a plurality of systems, the relay station apparatus including:
a memory, and
at least one processor connected to the memory, wherein the processor acquires the quality between the terminal apparatus and each base station apparatus for which the relay station apparatus performs relaying, and the relay station apparatus for each system, and
determines a data transmission method for each of a communication path between each base station apparatus and the relay station apparatus and a communication path between the relay station apparatus and the terminal apparatus on the basis of the quality and the priority of the terminal apparatus.

### Appendix 7

A data transmission method determination method in a wireless communication system including a relay station apparatus capable of relaying wireless communication between one or more base station apparatuses and a terminal apparatus using a plurality of systems, and a control apparatus, wherein the relay station apparatus acquires the quality between the terminal apparatus and each base station apparatus for which the relay station apparatus performs relaying, and the relay station apparatus for each system, and notifies the control apparatus of the acquired quality, and
the control apparatus determines a data transmission method for each of a communication path between each base station apparatus and the relay station apparatus and a communication path between the relay station apparatus and the terminal apparatus on the basis of the quality and the priority of the terminal apparatus, and notifies the relay station apparatus of the determined data transmission method.

Although the embodiment has been described above, the present invention is not limited to such a specific embodiment, and various modifications and changes can be made within the scope of the gist of the present invention described in the claims.

### REFERENCE SIGNS LIST

10 Relay station apparatus
11 Information acquisition unit
12 Transmission method selection unit
13 Control unit
14 DB
15 Information transmission unit
16 Wireless transmission and reception unit
20 Terminal apparatus
21 Wireless transmission and reception unit
30 Base station apparatus
31 Wireless transmission and reception unit
40 Control apparatus
41 Information acquisition unit
42 Transmission method selection unit
43 Information transmission unit
44 DB
50 Upper NW
1000 Drive apparatus
1001 Recording medium
1002 Auxiliary storage apparatus
1003 Memory apparatus
1004 CPU
1005 Interface apparatus
1006 Display apparatus
1007 Input apparatus
1008 Output apparatus

1. A wireless communication system comprising a processor configured to execute operations comprising:
relaying, by a relay station apparatus, wireless communication between one or more base station apparatuses and a terminal apparatus by using a plurality of systems;
acquiring, by the relay station apparatus, quality information of relay between the relay station apparatus and at least one of the terminal apparatus and each base station apparatus for which the relay station apparatus performs relaying;
notifying, by the relay station apparatus, the control apparatus of the acquired quality information;
determining, by the control apparatus, a type of a data transmission operation for each of a communication path between each base station apparatus and the relay station apparatus and a communication path between the relay station apparatus and the terminal apparatus on the basis of the quality information and a priority of the terminal apparatus: and
notifying notifies the relay station apparatus of the determined type of a data transmission operation.

2. The wireless communication system according to claim 1, wherein the type of the data transmission operation comprises at least one of redundant transmission, division transmission, or selective transmission.

3. The wireless communication system according to claim 1, wherein the control apparatus determines the type of the data transmission operation for each communication path by referring to a table describing a relationship between priority and the type of the data transmission operation.

4. The wireless communication system according to claim 1, wherein, when the priority of the terminal apparatus represents a first priority, the control apparatus determines a type of a data transmission operation using less resources than an amount of resources used in another type of data transmission operation determined for a second priority higher than the first priority.

5. A control apparatus in a wireless communication system, the control apparatus comprising a processor configured to execute operations comprising:
acquiring, from a relay station apparatus in the wireless communication system, quality information of relay between the relay station apparatus and at least one of a terminal apparatus and each base station apparatus for which the relay station apparatus performs relaying, wherein the wireless communication system further comprises the terminal apparatus and said each base station apparatus of a plurality of base station apparatuses;
determining a type of a data transmission operation for each of a communication path between each base station apparatus and the relay station apparatus and a communication path between the relay station apparatus and the terminal apparatus on the basis of the quality information and a priority of the terminal apparatus; and
notifying the relay station apparatus of the type of a determined data transmission operation.

6. A relay station apparatus comprising a processor configured to execute operations comprising:
acquiring quality information of relay between the relay station apparatus and at least one of a terminal apparatus and each base station apparatus for which the relay station apparatus performs relaying, and the relay station apparatus for each system;
determining a type of a data transmission operation for each of a communication path between each base station apparatus and the relay station apparatus and a communication path between the relay station apparatus and the terminal apparatus on the basis of the quality information and a priority of the terminal apparatus.

7. (canceled)

8. The control apparatus according to claim 5, wherein the type of the data transmission operation comprises at least one of redundant transmission, division transmission, or selective transmission.

9. The control apparatus according to claim 5, wherein the control apparatus determines the type of the data transmission operation for each communication path by referring to a table describing a relationship between priority and the type of the data transmission operation.

10. The control apparatus according to claim 5, wherein, when the priority of the terminal apparatus represents a first priority, the control apparatus determines a type of a data transmission operation using less resources than an amount of resources used in another type of data transmission operation determined for a second priority higher than the first priority.
